(19) United States
(12) Patent Application Publication
(10) Pub. No.: US 2008/0172521 A1
(43) Pub. Date: Jul. 17, 2008

(54) Memory System Determining Storage Mode According to Host Provided Data Information

(75) Inventor: Bong-Ryeol Lee, Seoul (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/839,917

(22) Filed: Aug. 16, 2007

(30) Foreign Application Priority Data
Jan. 16, 2007 (KR) 2007-04894

(51) Int. Cl. G06F 12/06

(52) U.S. Cl. 711/103; 711/E12.008

(57) ABSTRACT

Some embodiments of the present invention provide a memory system including a flash memory including a plurality of memory cells and a memory controller configured to receive data information from a host and to selectively store data in the flash memory in single-bit and multi-bit storage modes responsive to the data information. The memory controller may be configured to store respective pages in respective ones of the single-bit and multi-bit modes.

### CROSS-REFERENCE TO RELATED APPLICATIONS

This U.S. non-provisional patent application claims priority under 35 U.S.C. § 119 of Korean Patent Application No. 2007-04894 filed on Jan. 16, 2007, the entire contents of which are hereby incorporated by reference.

### BACKGROUND

The present invention relates to memory systems and more particularly, to memory systems with multiple storage modes.

Portable apparatus employing nonvolatile memories are increasing in use. For example, nonvolatile memories are commonly embedded as storage units in MP3 players, digital cameras, mobile phones, camcorders, flash cards, solid state disks (SSDs), and other devices.

Memory capacity of nonvolatile memories used as storage units is also generally increasing. One way of increasing the memory capacity is a multi-level cell (MLC) mode that stores multiple bits in a unit memory cell.

FIG. 1 is a block diagram of a memory system. Referring to FIG. 1, the memory system 100 includes a host 110, a memory controller 120, and a flash memory 130.

The memory controller 120 includes a buffer memory 121. The flash memory 130 includes a cell array 131 and a page buffer 132. The flash memory 130 may also include a decoder, a data buffer, and a control unit.

The memory controller 120 receives data and a write command from the host 110, and controls the flash memory 130 to write the received data into the cell array 131. Further, the memory controller 120 operates to control the flash memory 130 to read data from the cell array 131 in compliance with a read command provided from the host 110.

The buffer memory 121 temporarily stores data to be written into or read from the flash memory 130. The buffer memory 121 transfers data stored therein temporarily by the memory controller 120 to the host 110 or the flash memory 130.

The cell array 131 of the flash memory 130 includes a plurality of memory cells. These memory cells are nonvolatile, retaining their data even without power supply. The page buffer 132 is provided to store data to be written into or data read from a selected page.

Memory cells of the flash memory 130 may be single-level cells (SLCs) or multi-level cells (MLCs) in accordance with the number of data bits stored in each cell. An SLC stores single-bit data, while an MLC stores multi-bit data.

An SLC stores a single data bit. The SLC is operable in two states according to distribution of threshold voltages. The SLC stores data “1” or “0” after a programming operation. For example, a memory cell storing data “1” may be referred as having an erased state, while a memory cell storing data “0” may be referred as having a programmed state. A memory cell having an erased state may be called an “on” cell and a memory cell having a programmed state may be called an “off” cell.

The flash memory 130 may conduct a programming operation in page units. The memory controller 120 transfers data to the flash memory 130 through the buffer memory 121 in pages during a programming operation.

The page buffer 132 temporarily stores data loaded from the buffer memory 121, and programs the loaded data into a selected page. After completing the programming operation, a program-verifying operation is carried out for verifying whether the data have been correctly programmed.

From a result of the program-verifying operation, if there is a program fail, programming and program-verifying operations are repeated with an incremented program voltage. After completely programming data corresponding to one page, the next data is received for the next programming operation.

An MLC stores multi-bit data. FIG. 2 shows a procedure of programming 2-bit data, i.e., a least significant bit (LSB) and a most significant bit (MSB), into a single memory cell. Referring to FIG. 2, a memory cell is programmed to have one of four states 11, 01, 10, and 00 in accordance with distribution of threshold voltages. A procedure of programming an LSB may be the same as that of the aforementioned SLC. A memory cell having the “11” state is programmed to have a state A depicted by a dotted line in accordance with an LSB.

The memory controller 120 transfers a page of data (data corresponding to one page) to the flash memory 130 from the buffer memory 121 in order to program an MSB. Referring to FIG. 2, a memory cell conditioned like the dotted curve A is programmed to have the “00” state (Program1) or the “10” state (Program2). A memory cell having the “11” state is maintained in the “11” state or programmed to be the “01” state (Program3) in accordance with an MSB.

Returning to FIG. 1, the memory system 100 may program multi-bit data into the cell array 131 of the flash memory 130 by way of the aforementioned procedure. In particular, multi-bit data are programmed by the successive steps of first programming an LSB and then programming an MSB into the memory cell that has been programmed with the LSB.

The MLC may provide increased storage capacity per area in a memory chip. Although the MLC may increase storage capacity of a memory chip, it may have slower programming or reading speed than an SLC. For instance, an SLC may be programmable in 200 microseconds, while an MLC may be programmable in 800 microseconds.

In addition, the MLC may have a greater probability of generating errors than an SLC. In particular, during a programming operation, there may be an error while programming an MSB even though there has been no error in programming an LSB. If the data is important data that requires assured reliability, such as security data, use of an MLC may cause data loss during the programming operation.

Typically, a user does not consume full capacity of data storage in a flash memory. For instance, if a flash memory has storage capacity of 8 Gb (gigabits), a user may consume a memory space about 1 Gb, not the full 8 Gb. As such, even when there is a margin of storage capacity in the flash memory, the conventional MLC may be inefficient due to a slow operation speed and may increase the likelihood of loss of important data.

### SUMMARY OF THE INVENTION

Some embodiments of the present invention provide a memory system including a flash memory including a plurality of memory cells. The memory system further includes a memory controller configured to receive data information from a host and to selectively store data in the flash memory in single-bit and multi-bit storage modes responsive to the received data information. The memory controller may be configured to store respective paces in respective ones of the single-bit and multi-bit modes.

In further embodiments, the memory controller may be configured to store storage mode information in a cell of the flash memory. For example, the memory controller may be configured to store storage mode information for a page of memory cells in a memory cell of a spare field of the page. In some embodiments, the memory controller may be configured to store storage mode information for plural blocks of memory cells in a single block of memory cells. In still further embodiments, the memory controller may include a mode indicator storage unit configured to store storage mode information in the mode indicator storage unit.

In some embodiments, the data information indicates an amount of the data. In further embodiments, the data information indicates a security characteristic of the data. The memory controller may be configured to store the data in a single-bit storage mode responsive to the data information indicating that the data includes security data.

According to additional embodiments, the memory controller may include a storage mode selector configured to receive the data information and to responsively generate a storage mode control signal. The memory controller may further include a control unit configured to control programming of the flash memory responsive to the storage mode control signal.

In some embodiments, the flash memory and the memory controller are integrated into a single memory card. The flash memory may include a NAND flash memory.

In additional embodiments of the present invention, a memory system includes a flash memory including a plurality of memory cells and a memory controller configured to receive data information from a host, to selectively store data in the flash memory in single-bit and multi-bit storage modes responsive to the data information and to store storage mode information for data stored in the flash memory. The data information may indicate an amount of the data and/or a security characteristic of the data. The memory controller may be configured to store the data in the single-bit storage mode responsive to the data information indicating that the data includes security data. The memory controller may include a storage mode selector configured to receive the data information and to responsively generate a storage mode control signal and a control unit configured to control programming of the flash memory responsive to the storage mode control signal.

The control unit may include a mode indicator storage unit configured to store storage mode information for data stored in the flash memory. The memory controller may be configured to conduct a reading operation on the flash memory unit in accordance with the storage mode information stored in the mode indicator storage unit. The mode indicator storage unit may include an electrically erasable and programmable read-only memory.

### BRIEF DESCRIPTION OF THE DRAWINGS

FIG. 1 is a block diagram of a conventional memory system;

FIGS. 2 and 3 are diagrams showing conventional operations for programming multi-bit data into a single memory cell;

FIG. 4 is a block diagram of a memory system according to some embodiments of the present invention;

FIG. 5 is a block diagram of a memory system according to additional embodiments of the present invention; and

FIG. 6 is a block diagram of a memory system according to further embodiments of the present invention.

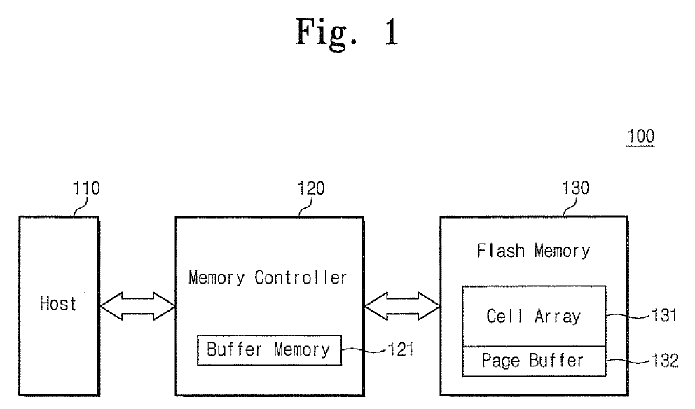

### DETAILED DESCRIPTION OF EMBODIMENTS

The invention is described more fully hereinafter with reference to the accompanying, drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the sizes or configurations of elements may be idealized or exaggerated for clarity.

It will be understood that when an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present. Like numbers refer to like elements throughout. As used herein, the term “and/or” includes any and all combinations of one or more of the associated listed items.

It will be understood that, although the terms first, second, third etc. may be used herein to describe various elements, components and/or sections, these elements, components and/or sections should not be limited by these terms. These terms are only used to distinguish one element, component, or section from another element, region or section. Thus, a first element, component or section discussed below could be termed a second element, component or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprisinig,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification, and will not be interpreted in an idealized or overly formal sense unless expressly so defined herein.

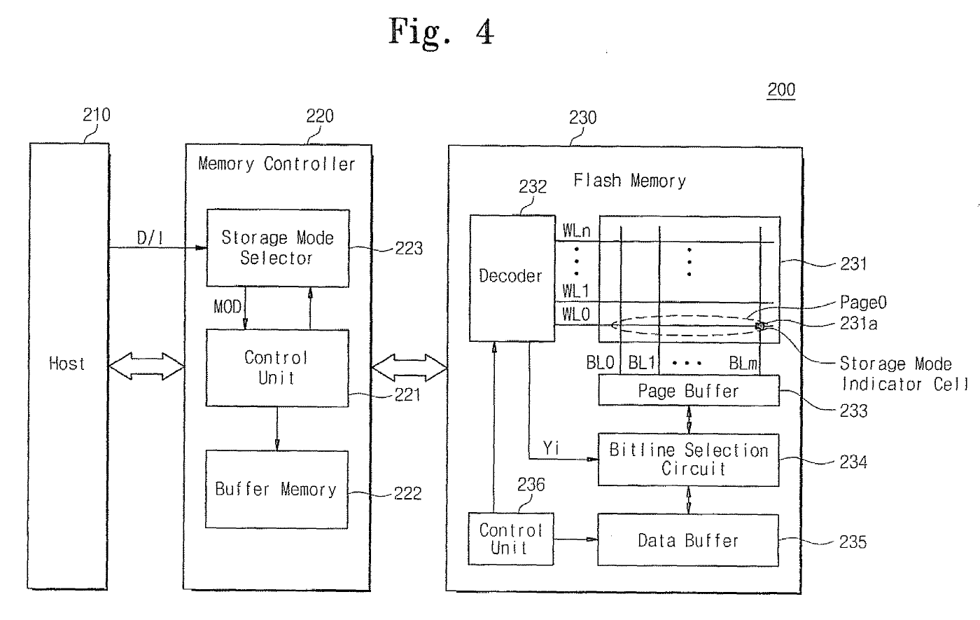

FIG. 4 is a block diagram of a memory system according to some embodiments of the present invention. Referring to FIG. 4, the memory system 200 includes a host 210, a memory controller 220 and a flash memory 230. The flash memory 230 is capable of storing data in single-bit (SLC) and multi-bit (MLC) modes.

In FIG. 4, the memory controller 220 and the flash memory 230 may be included in a single memory card. This memory card may be, for example, a Multimedia Card (MMC), a Secure Digital (SD) card, an eXtreme Digital (XD) card, a CompactFlash (CF) card, or a subscriber identification module (SIM) card. The memory card is used in connection with the host 210, such as a personal computer, a notebook or laptop computer, a mobile phone, an MP3 player, or a portable multimedia player (PMP).

The memory controller 220 operates to control functions (e.g., writing and reading operations) of the flash memory 230. The memory controller 220 includes a control unit 221, a buffer memory 222, and a storage mode selector 223.

The control unit 221 receives a command and control signal from the host 210. The control unit 221 operates to control the buffer memory 222 and the storage mode selector 223 in compliance with an input command, enabling the flash memory 230 to be operable in accordance with the command.

The buffer memory 222 is used to temporarily store data to be written into the flash memory 230 or data read from the flash memory 230. Data stored in the buffer memory 299 is transferred to the flash memory 230 or the host 210 by the control unit 221. The buffer memory 222 may be implemented in a random access memory (RAM), e.g., a static or dynamic RAM.

The memory controller 220 of the memory system 200 according to the illustrated embodiments of the present invention includes the storage mode selector 223. The storage mode selector 223 operates to select a storage mode for the flash memory 230. In particular, the storage mode selector 223 enables the flash memory 230 to be operable in an SLC mode or an MLC mode. The storage mode selector 223 receives data information D/I from the host 210. The data information D/I is information about data to be programmed in the flash memory 230, For example, information about the amount of data size or a security characteristic of the data.

The storage mode selector 223 receives the data information D/I from the host 210 and generates a storage mode control signal MOD. The storage mode control signal MOD is provided to tile control unit 221. The control unit 221 operates to control the flash memory 230 in the SLC or MLC mode responsive to the storage mode control signal MOD.

For example, in programming security data into the flash memory 230, the host 210 may provide data information D/I together with the security data. The storage mode selector 223 receives information about the security data from the host 210 and generates the storage mode control signal MOD. During this, the storage mode control signal MOD is operative in activating the flash memory 230 in the SLC mode (hereinafter, referred to as “SLC mode signal”). Because it is desirable that the security data is free from an error during a programming operation, it may be programmed in the SLC mode to potentially reduce the probability of error.

The storage mode selector 223 may receive data information D/I about a data size of program data. The storage mode selector 223 may generate an SLC mode signal if there is a relatively large storage capacity margin for the flash memory 230, and may generate an MLC mode signal if there is a relatively small storage capacity margin for the flash memory 230. In the latter situation, the MLC mode signal is provided to operate the flash memory 230 in the MLC mode.

Still referring to FIG. 4, the flash memory 230 includes a cell array 231, a decoder 232, a page buffer 233, a bit-line selection circuit 234, a data buffer 235, and a control unit 236. FIG. 4 shows a NAND flash memory as an example.

The cell array 231 includes plural blocks. Each memory block includes plural pages (e.g., 32 or 62 pages). Each page includes plural memory cells (e.g., 512 or 2K Bytes). In the NAND flash memory, an erasing operation may be carried out in units of memory blocks, while reading and writing operations may be carried out in units of pages.

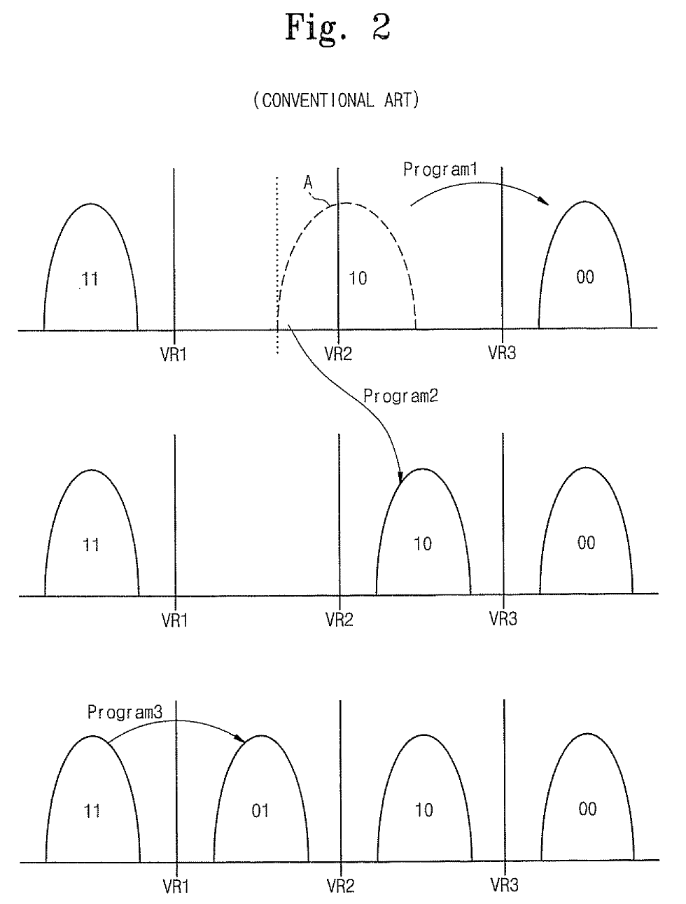

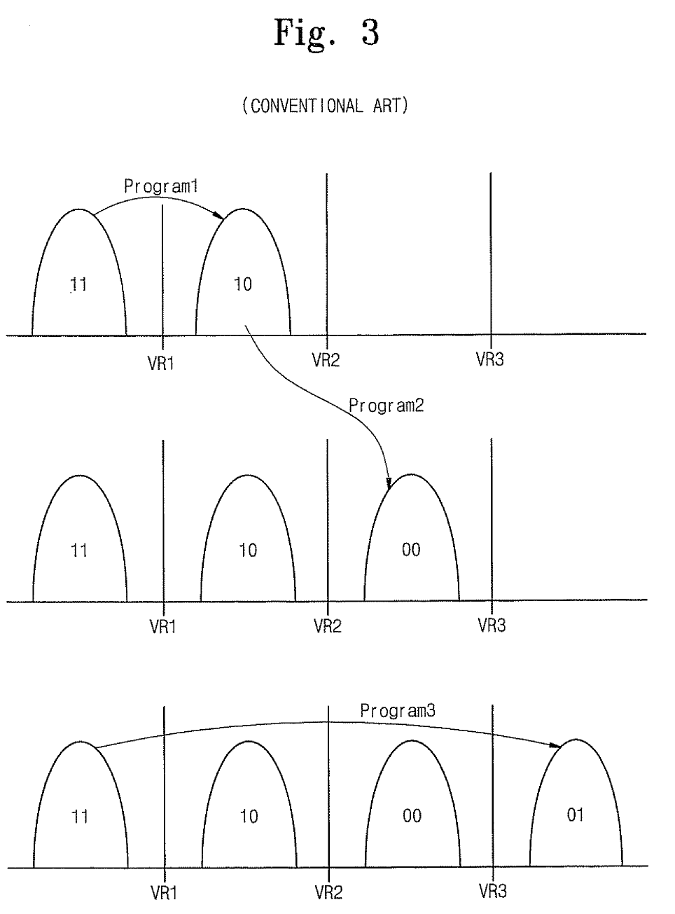

Referring to FIGS. 2 and 3, in a case of storing 2-bit data in a unit memory cell, each memory cell may have four states or levels in accordance with distribution of threshold voltages. Hereinafter will be described a case of storing 2-bit data in a unit memory cell. However, some embodiments of the present invention include cases of storing multi-bit data more than 2 bits (e.g., 3 or 4 bits) in a unit memory cell.

Referring again to FIG. 4, each page is operable in the SLC or MLC mode in accordance with the storage mode control signal MOD. During this, a unit memory cell of one page stores single-bit data or multi-bit data (e.g., 2-bit data). A unit page includes a storage mode indicator cell, e.g., a selected page Page0 includes a single storage mode indicator cell 231a. The storage node indicator cell 231a stores information about a storage mode for the selected page Page0, i.e., whether page is stored in an SLC mode or an MLC mode.

In some embodiments, the cell array 231 may be divided into data and spare fields. If a unit page size is 528 Bytes, 512 Bytes may be stored in the data field while 16 Bytes may be stored in the spare field. The storage mode indicator cell 231a may be included in the spare field. The flash memory 230 stores information about a storage mode of the selected page Page0 in the storage mode indicator cell 231a of the spare field during a programming operation. The flash memory 230 executes a reading operation in the SLC or MLC mode in accordance with the storage mode information set in the storage mode indicator cell 231a.

The decoder 232 is connected to the cell array through word lines WL0˜WLn, and is operated by the control unit 236. The decoder 232 receives an address ADDR from the memory controller 220 and responsively generates a selection signal Yi to designate a word line (e.g., WL0) or a bit line (BL). The page buffer 233 is connected to a cell array 231 through the bit lines BL0˜BLm.

The page buffer 233 stores data loaded from the buffer memory 222. Data of one page is loaded into the page buffer 233. The loaded data is programmed in a selected page (e.g., Page0) at the same time during a programming operation. The page buffer 233 reads data from the selected page Page0 during a reading operation, and temporarily stores the read data therein. Data stored in the page buffer 233 are transferred to the buffer memory 222 in response to a read-enable signal.

The bit-line selection circuit 234 is provided to select a bit line in response to the selection signal Yi. The data buffer 235 functions as an input/output buffer used for data transmission between the memory controller 220 and the flash memory 230. The control unit 236 receives a control signal from the memory controller 220, controlling an internal operation of the flash memory 230.

The memory system 200 according to the embodiments of the present invention illustrated in FIG. 4 includes the storage mode selector 223 in the memory controller 220. The storage mode selector 223 receives data information D/I from the host 210 and generates the storage mode control signal MOD. Tile control unit 221 enables the flash memory 230 to be programmed in the SLC or MLC mode in compliance with the storage mode control signal MOD. The flash memory 230 stores information about the storage mode (SLC or MLC mode) in the spare field of the selected page Page0 during a programming operation, and conducts a reading operation in accordance with the stored mode information.

The memory system 200 shown in FIG. 4 may make the flash memory 230 operate in the SLC mode when there is a relatively large amount of storage space available in the flash memory 230 and/or if data to be stored is important. According to some embodiments of the present invention, data are stored in the SLC or MIC mode in accordance with the data information D/I, which may be helpful in enhancing a programming speed and/or reducing a rate of data error.

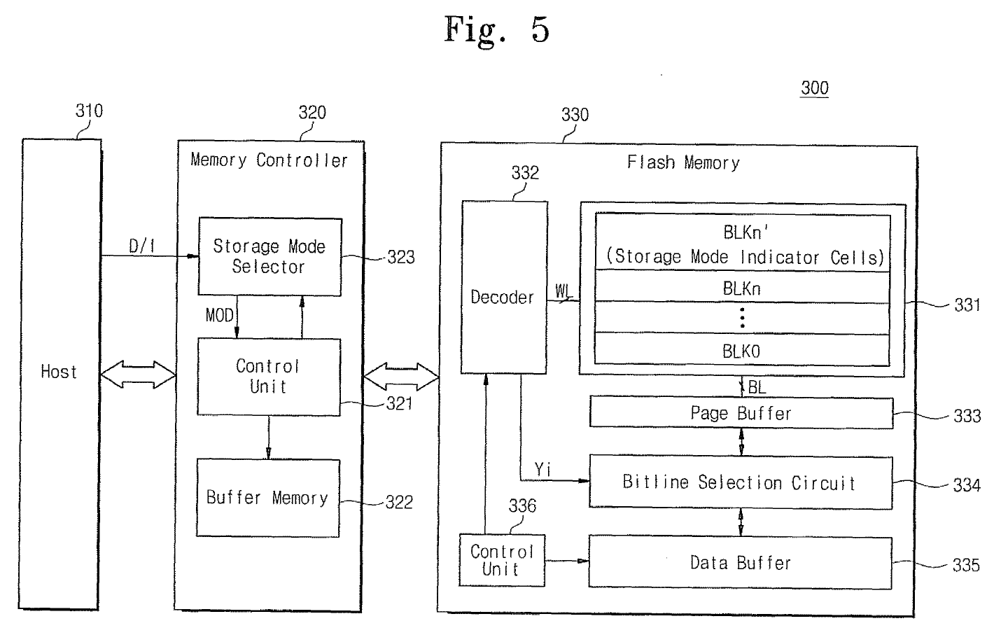

FIG. 5 is a block diagram of a memory system according to additional embodiments of the present invention. Referring to FIG. 5, the memory system 300 according to the present invention includes a host 310, a memory controller 320, and a flash memory 330. The memory controller 320 includes a control unit 321, a buffer memory 322, and a storage mode selector 323. These components may operate as described above with reference to FIG. 4.

Referring to FIG. 5, the cell array 231 includes plural memory blocks BLK0˜BLKn and BLKn′. Each memory block includes plural pages. Each page is operable in the SLC or MLC mode in compliance with the storage mode control signal MOD. Each memory cell of a page stores single-bit data or multi-bit data (e.g., 2 bits) in response to the storage mode control signal MOD.

Information about storage mode is stored in a memory block BLKn′, not in the spare field of each page. In other words, the flash memory 330 stores all information about storage modes (SLC or MLC mode) for pages in blocks BLK0-BLKn in the memory block BLKn′. The flash memory 330 conducts a reading operation in the SLC or MLC mode in accordance with the storage mode information stored in the memory block BLKn′.

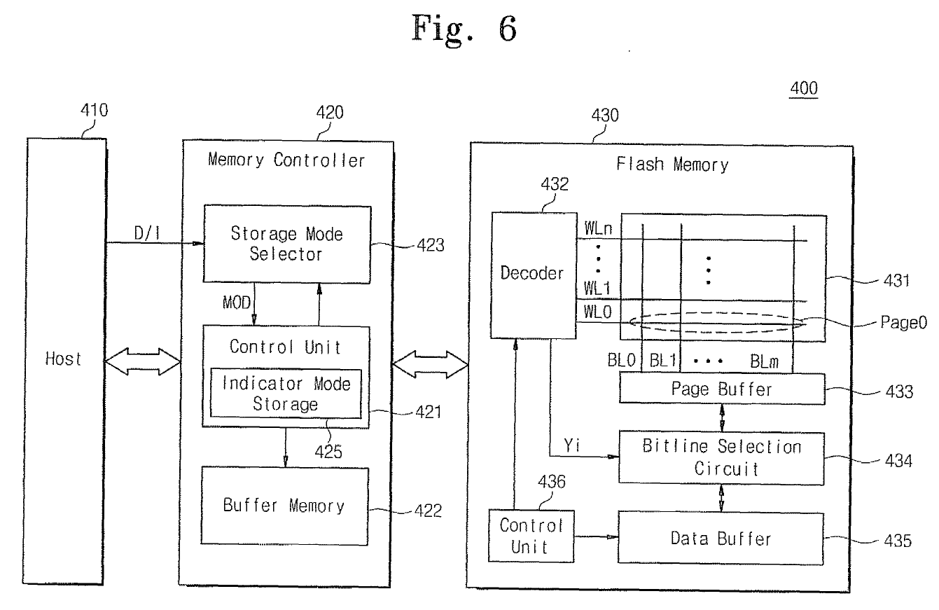

FIG. 6 is a block diagram of a memory system according to further embodiments of the present invention. Referring to FIG. 6, the memory system 400 according to the illustrated embodiments of the present invention includes a host 410, a memory controller 420, and a flash memory 430. The memory controller 420 includes a control unit 421, a buffer memory 422, and a storage mode selector 423.

The control unit 421 includes a mode indicator storage unit 425. The mode indicator storage unit 425 stores information about storage modes (SLC or MLC mode) of data in the flash memory 430. In particular, the memory controller 420 stores information about storage modes (SLC or MLC mode) for pages (e.g., Page0) stored in the flash memory 430 in the mode indicator storage unit 425 of the control unit 421. The memory controller 420 conducts reads operations on the flash memory 430 in the SLC or MLC mode in accordance with the storage mode information stored in the mode indicator storage unit 425. The mode indicator storage unit 425 may be implemented in, for example, a register, or an electrically erasable and programmable read-only memory (EEPROM).

As stated above, a memory system according to some embodiments of the present invention receives data information from the host and determines a storage mode of the flash memory in accordance with the data information. If there is a relatively large amount of storage space available in the flash memory and/or if data to be stored is important, the flash memory may be operated in an SLC mode. According to some embodiments of the present invention, because a storage mode is determined by the data information D/I, it may be possible to enhance programming speed and/or reduce a data error rate. Embodiments of the present invention may be advantageous to make a programming operation faster and data errors reduced because a storage mode (the SLC or MLC mode) may be conditionally determined with reference to the data information D/I provided from the host.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims.

What is claimed is:

1. A memory system comprising:
a flash memory comprising a plurality of memory cells; and
a memory controller configured to receive data information from a host and to selectively store data in the flash memory in single-bit and multi-bit storage modes responsive to the received data information.

2. The memory system of claim 1, wherein the memory controller is configured to store respective pages in respective ones of the single-bit and multi-bit modes.

3. The memory system of claim 1, wherein the memory controller is configured to store storage mode information in a cell of the flash memory.

4. The memory system of claim 3, wherein the memory controller is configured to store storage mode information for a page of memory cells in a memory cell of a spare field of the page.

5. The memory system of claim 3, wherein the memory controller is configured to store storage mode information for plural blocks of memory cells in a single block of memory cells.

6. The memory system of claim 2, wherein the memory controller includes a mode indicator storage unit configured to store storage mode information.

7. The memory system of claim 1, wherein the data information indicates an amount of the data.

8. The memory system of claim 1, wherein the data information indicates a security characteristic of the data.

9. The memory system of claim 7, wherein the memory controller is configured to store the data in a single-bit storage mode responsive to the data information indicating that the data comprises security data.

10. The memory system of claim 1, wherein the memory controller comprises:
a storage mode selector configured to receive the data information and to responsively generate a storage mode control signal; and
a control unit configured to control programming of the flash memory responsive to the storage mode control signal.

11. The memory system of claim 1, wherein the flash memory and the memory controller are integrated into a single memory card.

12. The memory system of claim 1, wherein the flash memory is a NAND flash memory.

13. The memory system of claim 1, further comprising the host.

14. A memory system comprising:
a flash memory comprising a plurality of memory cells; and
a memory controller configured to receive data information from a host, to selectively store data in the flash memory in single-bit and multi-bit storage modes responsive to the data information and to store storage mode information for data stored in the flash memory.

15. The memory system of claim 14, wherein the data information indicates an amount of the data.

16. The memory system of claim 14, wherein the data information indicates a security characteristic of the data.

17. The memory system of claim 14, wherein the memory controller is configured to store the data in the single-bit storage mode responsive to the data information indicating that the data comprises security data.

18. The memory system of claim 14, wherein the memory controller comprises:
a storage mode selector configured to receive the data information and to responsively generate a storage mode control signal; and
a control unit configured to control programming of the flash memory responsive to the storage mode control signal.

19. The memory system of claim 18, wherein the control unit comprises a mode indicator storage unit configured to store the storage mode information.

20. The memory system of claim 19, wherein the memory controller is configured to conduct a read operation on the flash memory unit in accordance with tile storage mode information stored in the mode indicator storage unit.

21. The memory system of claim 19, wherein the mode indicator storage unit comprises an electrically erasable and programmable read-only memory.

22. The memory system of claim 14, wherein the flash memory and the memory controller are integrated into a single memory card.

23. The memory system of claim 14, wherein the flash memory comprises a NAND flash memory card.
